(19) United States
(12) Patent Application Publication
(10) Pub. No.: US 2014/0226640 A1
(43) Pub. Date: Aug. 14, 2014

(54) METHOD AND APPARATUS FOR TIMING ADVANCE ADJUSTMENT IN MULTI-POINT COOPERATION TRANSMISSION

(71) Applicant: Alcatel Lucent, Paris (FR)

(72) Inventors: Xudong Zhu, Shanghai (CN); Tao Yang, Shanghai (CN); Jin Liu, Shanghai (CN)

(73) Assignee: ALCATEL LUCENT, Paris (FR)

(21) Appl. No.: 14/345,844

(22) PCT Filed: Sep. 21, 2012
(86) PCT No.: PCT/IB2012/002171

§ 371 Date: Mar. 19, 2014

(30) Foreign Application Priority Data
Sep. 30, 2011 (CN) 201110296399.9

(51) Int. Cl. H04L 5/00

(52) U.S. Cl. CPC H04L 5/0035; H04L 5/0051; H04L 5/0028
USPC 370/336

(57) ABSTRACT

Embodiments of the present invention provide a method and apparatus for timing advance adjustment in multi-point cooperation transmission, wherein the method comprises receiving, at one or more reception points, an uplink reference signal from a user equipment; selecting, based on signal quality of the uplink reference signal, one of the one or more reception points as a reference point for the user equipment to adjust timing advance; and indicating a selected reference point to the user equipment. With the method and apparatus in the embodiments of the present invention, a user equipment may be provided with a suitable reception point as a reference point so that the user equipment can efficiently adjust the timing advance timing advance based on the time situation of receiving signals from the reference point so as to overcome inter-symbol-interference at the reception point, improve the receiving efficiency of the reception point, and thereby to improve the whole performance of a multi-point cooperation transmission system.

### FIELD OF THE INVENTION

Embodiments of the present invention generally relate to wireless communication technology. More particularly, the embodiments of the present invention relate to a method and apparatus for timing advance adjustment in multi-point cooperation transmission.

### BACKGROUND OF THE INVENTION

In a wireless communication system, Coordinated Multi-Point transmission/reception (CoMP) or multi-point cooperation transmission is an important technology for significantly improving cell throughput and edge user rate, wherein uplink multi-point cooperation reception relates to multiple geographically separated reception points (e.g. a base station, a repeater or a Remote Radio Head RRH) jointly receiving and processing data of User Equipment (“UE” for short). To correctly receive data, it is necessary to perform uplink synchronization for UE and multiple reception points, which generally relates to UE's timing advance adjustment.

In a CoMP system, the uplink synchronization means that UE's uplink transmission should arrive at a corresponding reception point within the time interval length of its Cyclic Prefix (CP). If the UE's uplink transmission arrives at a reception point before or after the time interval length of its cyclic prefix, the reception point cannot correctly decode the received data due to inter-symbol-interference from the UE so that the reception performance is deteriorated and further the performance of the CoMP system is jeopardized seriously. The situation of uplink transmission from the UE to multiple reception points will be exemplarily described below by making reference to FIG. 1.

The upper half portion of FIG. 1 exemplarily illustrates a CoMP system that includes reception points 1, 2, 3 and a UE 101, wherein it is illustrated by arrows that the UE 101 sends data frames in a CP additional data form to the reception points 1, 2 and 3 respectively at propagation delays t1, t2 and t3. The lower half portion of FIG. 1 exemplarily illustrates the receiving situations of data frames at the reception points 1, 2 and 3. It can be seen from FIG. 1 that due to different propagation delays, in the same reception time window, since the uplink data frames of the UE 101 arrive at the reception point 1 after its CP time length, the reception point 1 cannot perform a correct decoding processing due to the inter-symbol-interference. On the contrary, since the uplink data frames of the UE 101 arrive at the reception points 2 and 3 just at the CP time length or within the CP time length, no inter-symbol-interference will be generated at the reception points 2 and 3.

To avoid inter-symbol-interference caused due to the abnormal arrival time at the reception point, extending the CP length can be considered so that the uplink transmission time to the reception points can fall into the CP time length interval. However, the solution of such extending CP length contains multiple drawbacks as below:

First, it is hard to determine an optimized CP length to cover different uplink CoMP scenarios. For example, for scenario where propagation delays to multiple reception points are similar, small CP length is enough and it is unnecessary to extend the CP length; otherwise, it will lead to a waster of resource. However, small CP length cannot be used for scenario where the propagation delays vary dramatically. Second, a lengthened CP will result in big overhead and lead to uplink capacity loss. The reason is that the symbols which should be used to send data is now occupied by the extended CP. Finally, the solution of extending the

CP length does not support a legacy UE and restricts scheduling flexibility since the UE in the CoMP system can only be scheduled in the frame with a longer CP length.

Further, the arrival time of UE's uplink signals at the reception point will keep changing due to movement of UE, change of propagation environments, oscillator drift in the UE and doppler shift, which brings a huge challenge to the synchronization between the UE and multiple reception points.

Thus, a method and apparatus for timing advance adjustment in the multi-point cooperation transmission is needed in the prior art. With the method and apparatus, a user equipment may be provided with a suitable reception point as a reference point so that the UE can efficiently adjust the timing advance based on the time situation of receiving signals from the reference point so as to improve the synchronization between UE and reception points, overcome the inter-symbol-interference at the reception point, and improve the receiving efficiency of the reception point, thereby improving the whole performance of the CoMP system.

### SUMMARY OF THE INVENTION

The technical problem to be solved by the present invention is: how to efficiently adjust timing advance of a user equipment in a CoMP system to thereby reduce the occurrence of inter-symbol-interference at a reception point and improve the whole performance of the CoMP system.

To solve the above problem, one aspect of the present invention provides a method for timing advance adjustment in multi-point cooperation transmission, comprising: receiving, at one or more reception points, an uplink reference signal from a user equipment; selecting, based on signal quality of the uplink reference signal, one of the one or more reception points as a reference point for the user equipment to adjust timing advance; and indicating a selected reference point to the user equipment.

According to one embodiment of the present invention, wherein the signal quality relates to signal strength or propagation delay of the uplink reference signal.

According to one embodiment of the present invention, wherein the indicating the selected reference point to the user equipment comprises indicating the selected reference point to the user equipment via radio resource control signaling.

Another aspect of the present invention provides a method for timing advance adjustment in multi-point cooperation transmission, comprising: recording a reception time of receiving a downlink reference signal from a reference point, wherein the reference point is one of the reception points in the multi-point cooperation transmission and is indicated via a serving base station; and adjusting the timing advance for uplink transmission based on the recorded reception time and a timing advance command from the serving base station.

According to one embodiment of the present invention, wherein the adjusting the timing advance comprises adjusting the timing advance during the interval of receiving different timing advance commands from the serving base station.

According to another embodiment of the present invention, wherein the adjusting the timing advance comprises: calculating a first difference between the reception time and an uplink transmission time determined by the timing advance command; recording a reception time of receiving a next downlink reference signal from the reference point, calculating a second difference between the next reception time and the determined uplink transmission time; and adjusting the timing advance based on a difference between the second difference and the first difference.

One aspect of the present invention provides an apparatus for timing advance adjustment in multi-point cooperation transmission, comprising: a module for receiving, at one or more reception points, an uplink reference signal from a user equipment; a module for selecting, based on signal quality of the uplink reference signal, one of the one or more reception points as a reference point for the user equipment to adjust timing advance; and a module for indicating a selected reference point to the user equipment.

Another aspect of the present invention provides an apparatus for timing advance adjustment in multi-point cooperation transmission, comprising: a module for recording a reception time of receiving a downlink reference signal from a reference point, wherein the reference point is one of the reception points in the multi-point cooperation transmission and is indicated via a serving base station; and a module for adjusting the timing advance for uplink transmission based on the recorded reception time and a timing advance command from the serving base station.

Another aspect of the present invention provides a base station and a user equipment respectively comprising the above apparatus.

With the method and apparatus for timing advance adjustment in multi-point cooperation transmission according to the present invention, a serving base station may indicate to a user equipment a suitable reception point as a reference point so that the user equipment can efficiently adjust the timing advance based on the time situation of receiving signals from the reference point so as to overcome inter-symbol-interference at the reception point, improve the receiving rate of the reception point, and thereby to bring an improvement in the whole performance of the CoMP system.

### BRIEF DESCRIPTION OF THE DRAWINGS

The above and other objects, features and advantages of the present invention will become apparent by making references to the following detailed descriptions of exemplary embodiments in conjunction with the accompanying drawings, in which:

FIG. 1 is a block diagram exemplarily illustrating a situation that in a CoMP system, a user equipment sends data frames to multiple reception points with different propagation delays and a reception point receives the data frames;

FIG. 2 is a flowchart exemplarily illustrating a method for timing advance adjustment in multi-point cooperation transmission according to an embodiment of the present invention;

FIG. 3 is a flowchart exemplarily illustrating a method for timing advance adjustment in multi-point cooperation transmission according to another embodiment of the present invention;

FIG. 4 is a detailed flowchart exemplarily illustrating a method for timing advance adjustment in multi-point cooperation transmission according to an embodiment of the present invention;

FIG. 5 is a schematic diagram illustrating timing advance adjustment at a user equipment according to an embodiment of the present invention;

FIG. 6 is a block diagram exemplarily illustrating an apparatus for timing advance adjustment in multi-point cooperation transmission according to an embodiment of the present invention; and

FIG. 7 is a block diagram exemplarily illustrating an apparatus for timing advance adjustment in multi-point cooperation transmission according to another embodiment of the present invention.

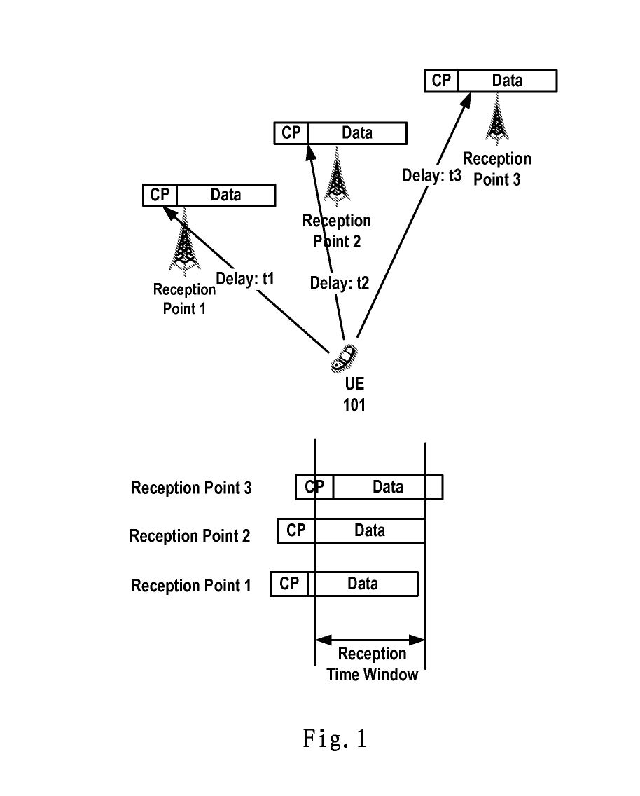

### DETAILED DESCRIPTION OF EMBODIMENTS

Specific embodiments of the present invention will be described below in detail by making references to the accompanying drawings.

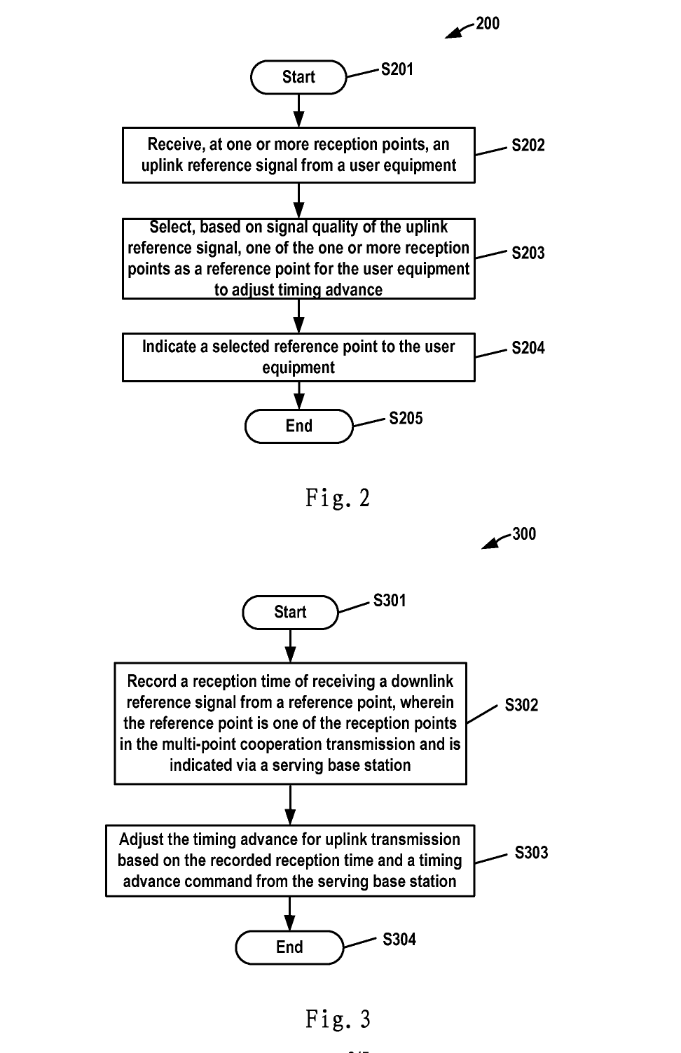

FIG. 2 is a flowchart exemplarily illustrating a method 200 for timing advance adjustment in multi-point cooperation transmission according to an embodiment of the present invention. As shown in FIG. 2, the method 200 starts at step S201. At step S202, the method 200 receives, at one or more reception points, an uplink reference signal from a UE, and the uplink reference signal, for example, includes a Demodulation Reference Signal (DM RS) and a Sounding Reference Signal (SRS).

Next, at step S203, the method 200 selects, based on signal quality of the uplink reference signal, one of the one or more reception points as a reference point for the UE to adjust timing advance. In one embodiment, the signal quality relates to signal strength or propagation delay of the uplink reference signal. For example, if an uplink reference signal received at a certain reception point has stronger signal strength or shorter propagation delay compared with other reception points in the user coordinated cluster, the certain reception point is more likely to be selected as a reference point.

Next, the method 200 proceeds to step S204. At step S204, the method 200 indicates a selected reference point to the UE. In one embodiment, a selected reference point may be indicated to the UE via Radio Resource Control (RRC) signaling. Finally, the method 200 ends at step S205.

With the method 200 in the above embodiments of the present invention, a suitable reception point may be selected as a reference point for UE's timing advance adjustment, by estimating the signal quality of an uplink reference signal transmitted from UE.

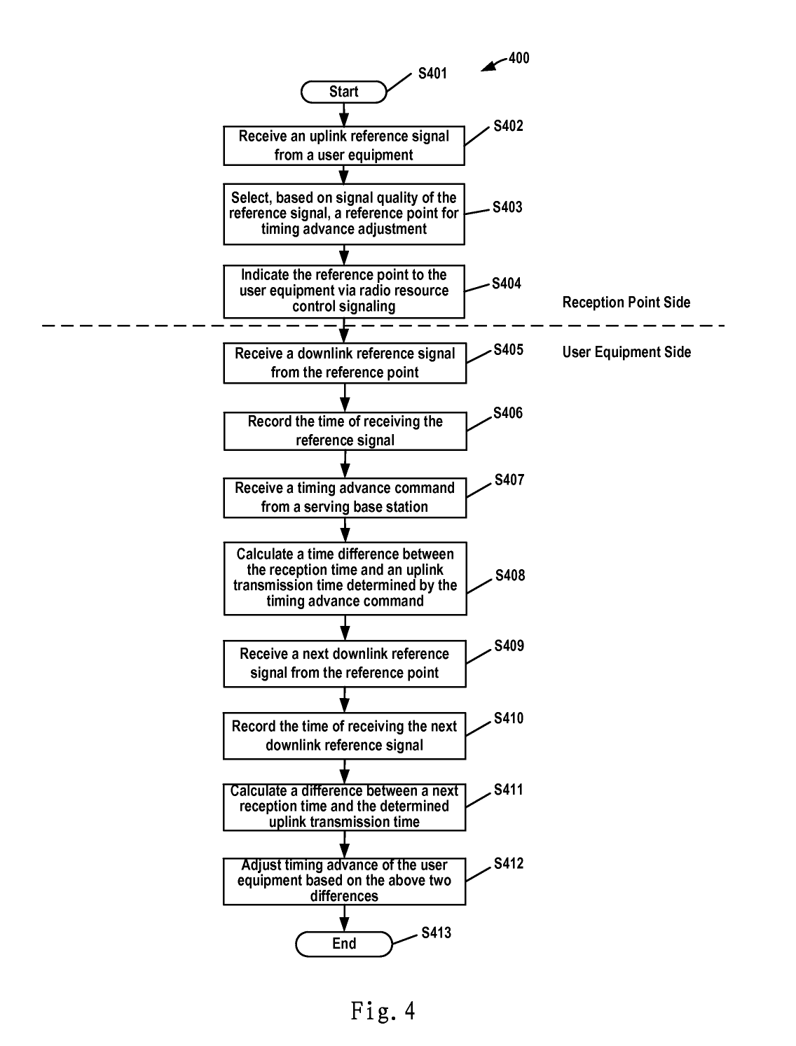

FIG. 3 is a flowchart exemplarily illustrating a method 300 for timing advance adjustment in multi-point cooperation transmission according to an embodiment of the present invention. As shown in FIG. 3, the method 300 starts at step S301. At step S302, the method 300 records a reception time of receiving a downlink reference signal from a reference point, wherein the reference point is one of the reception points in the multi-point cooperation transmission and is indicated via a serving base station, e.g., the reference point that is selected by the above method 200 and is indicated to UE.

Next, at step S303, the method 300 adjusts timing advance for uplink transmission based on the recorded reception time and a timing advance command from a serving base station. In an embodiment, the adjusting timing advance for uplink transmission comprises adjusting the timing advance during the interval of receiving different timing advance commands from the serving base station. Further, the adjusting timing advance comprises calculating a first difference between the reception time and an uplink transmission time determined by the timing advance command; recording a reception time of receiving a next downlink reference signal from the reference point; calculating a second difference between the next reception time and the determined uplink transmission time; and adjusting the timing advance based on a difference between the second difference and the first difference.

Finally, the method 300 ends at step S304.

With the method 300 in the above embodiments of the present invention, the UE may adjust timing advance by utilizing the reception time of the downlink reference signal of the reference point indicated by the serving base station so as to keep synchronization with multiple reception points as much as possible and to avoid inter-symbol-interference caused at the reception point when a data frame is sent at an improper time.

FIG. 4 is a detailed flowchart exemplarily illustrating a method 400 for timing advance adjustment in multi-point cooperation transmission according to an embodiment of the present invention. As shown in FIG. 4, the method 400 starts at step S401. At step S402, the method 400 receives an uplink reference signal from a UE, and the uplink reference signal may be used to estimate the signal quality related to signal strength or propagation delay. Next, at step S403, the method 400 selects, based on signal quality of the uplink reference signal, one of the one or more reception points as a reference point for UE to execute timing advance adjustment in uplink transmission, and the reference point, for example, may be the base station, RRH or repeater nearest to the UE even though it does not provide a service to the UE. The above selection, for example, may be achieved by a control unit set in the user coordinated cluster, and the control unit may be set in advance by the system and it may physically coexist with the serving base station but be at a high layer of the protocol stack so as to execute coordination or control between multiple reception points in the user coordinated cluster.

The method 400 then proceeds to step S404, wherein the method 400 indicates the reference point to UE via RRC signaling, for example, sends singling information including a reference point identifier to the UE via the serving base station. Here, the method 400 achieves respective steps at the reception point side.

Next, the method 400 advances to step S405. At step S405, the method 400 receives an uplink reference signal from the reference point, and the reference point is just the reference point indicated by the serving base station. At step S406, the method 400 records the reception time of receiving the reference signal. Next, at step S407, the method 400 receives a timing advance command (sent periodically) from the serving base station, and the timing advance command comprises the amount of time about next transmission time needed to be adjusted by the UE. At step S408, the method 400 calculates a time difference between the reception time and an uplink transmission time included (or determined) by the timing advance command, and the time difference is called as a first difference here. Next, the method 400 receives, at step S409, a next downlink reference signal from the reference point, and similarly, records, at step S410, the reception time of receiving the next reference signal.

The method 400 then proceeds to step S411. At step S411, the method 400 will calculate a time difference between a next reception time and the determined uplink transmission time, and the time difference is called as a second difference here. Next, the method 400 proceeds to step S412, wherein the method 400 adjusts timing advance of a user equipment based on the above two differences. For example, the difference between the two differences may be further calculated, and if the calculated difference is greater than a certain preset threshold, the UE may determine that it is necessary to adjust the next uplink transmission time. Finally, the method 400 ends at step S413.

With the method 400 in the above embodiments of the present invention, the UE may autonomously adjust timing advance by utilizing the reception time of the downlink reference signal of the reference point in combination with the periodically received timing advance command so as to keep synchronization with multiple reception points and avoid inter-symbol-interference caused at the reception point when a data frame is sent at an improper time.

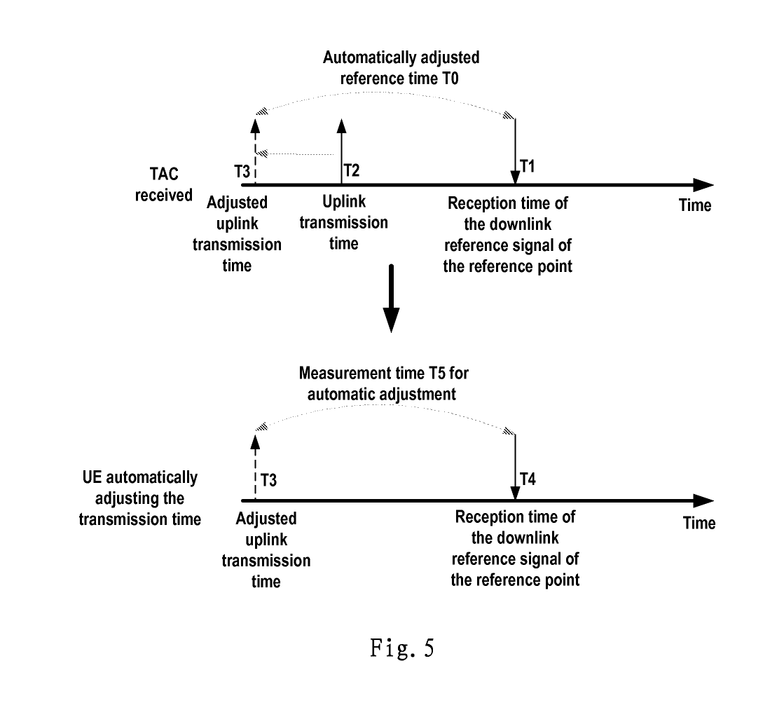

To facilitate a better understanding of the above embodiments of the present invention, the operation of determining timing advance adjustment at the UE will be described below with reference to FIG. 5. FIG. 5 is a schematic diagram illustrating timing advance adjustment at the UE according to an embodiment of the present invention, wherein the time axis and respective arrows indicating time points are merely exemplary and do not strictly represent the order in time.

As shown in the upper half portion of FIG. 5, at the time point T1 indicated by an arrow, the UE receives a downlink reference signal from the reference point and records the reception time point when UE receives a Timing Advance Command (TAC) from a serving base station, and the command is assumed to include information of bringing forward the next transmission time, for example, bringing forward the uplink transmission time T2 to T3 as shown in FIG. 5, i.e. the adjusted uplink transmission time. At that time, the UE may calculate the reference time for its autonomously adjusting timing advance by T0=T3−T1, i.e. the first difference in the method 400.

Next, as shown in the lower half portion of FIG. 5, based on the TAC command, the UE executes transmission at the adjusted uplink transmission time point T3, and again receives the downlink reference signal from the reference point and records the reception time point T4. Next, the UE may calculate the measurement time for automatic adjustment by T5=T4−T3, i.e. the second difference in the method 400. Thereafter, the difference between T5 and TO may be further calculated, and if the difference is greater than a certain preset time value, the UE may correspondingly execute autonomous adjustment. For example, if the difference is greater than a preset time value, it indicates that the transmission time is early, then the UE may postpone the next transmission time backward by adjusting the timing advance, as shown in the upper portion of FIG. 5. Before receiving the next TAC command, UE may repeatedly execute the above adjusting operation to keep synchronization with multiple reception points as much as possible.

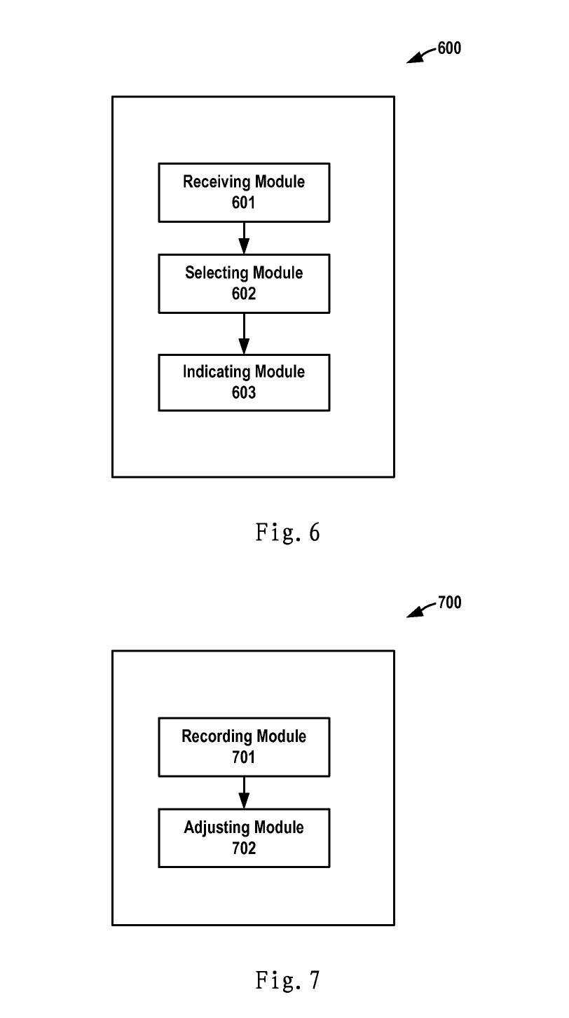

FIG. 6 is a block diagram illustrating an apparatus 600 for timing advance adjustment in multi-point cooperation transmission according to an embodiment of the present invention. The apparatus 600 comprises a receiving module 601, a selecting module 602 and an indicating module 603. In the apparatus 600, the receiving module 601 is for receiving, at one or more reception points, an uplink reference signal from a user equipment (i.e. executing step S202 in the method 200); the selecting module 602 is for selecting, based on signal quality of the uplink reference signal, one of the one or more reception points as a reference point for the user equipment to adjust timing advance (i.e. executing step S203 in the method 200), while the indicating module 603 is for indicating the selected reference point to the user equipment (i.e. executing step S204 in the method 200). It can be seen that the method 200 shown in FIG. 2 may be achieved by executing the apparatus 600.

FIG. 7 is a block diagram illustrating an apparatus 700 for timing advance adjustment in multi-point cooperation transmission according to an embodiment of the present invention. The apparatus 700 comprises a recording module 701 and an adjusting module 702. In the apparatus 700, the recording module 701 is for recording a reception time of receiving a downlink reference signal from a reference point, wherein the reference point is one of the reception points in the multi-point cooperation transmission and is indicated via a serving base station (i.e. executing step S302 in the method 300); the adjusting module 702 is for adjusting the timing advance for uplink transmission based on the recorded reception time and a timing advance command from the serving base station (i.e. executing step S303 in the method 300). It can be seen that the method 300 shown in FIG. 3 may be achieved by executing the apparatus 700.

Although not shown in a form of drawings, those skilled in the art may understand, based on a disclosure or teaching of the specification, that the method or apparatus of the present invention may be implemented in corresponding base station or user equipment to thereby achieve an accurate timing advance adjustment.

To sum up, respective embodiments of the present invention are described in detail with reference to the accompanying drawings. Those skilled in the art could understand that embodiments of the present invention may be implemented by hardware, software, firmware, module or a combination thereof, and may also embody the present invention in a computer program product configured on a signal bearing medium for use in any suitable data processing system. The signal bearing medium may be a transmission medium or a recordable medium for use in machine readable information, including a magnetic medium, an optical medium or other suitable medium. The examples of the recordable medium comprises: a disk or a floppy disk in a hard disk drive, an optical disk for use in an optical drive, a magnetic tape and other media that can be thought of by those skilled in the art. Those skilled in the art should recognize that any communication terminal having a suitable programming module will be able to execute the steps of the method of the present invention as reflected in the program product.

It should be noted that to facilitate the understanding of the present invention, some more specific technical details that are well-known to those skilled in the art and may be necessary for implementing the present invention are omitted in the above descriptions.

Although specific embodiments of the present invention have been disclosed, those skilled in the art would understand that changes may be made for specific embodiments without departure from the spirit and scope of the present invention. Thus, the present invention is not limited to specific embodiments, and the attached claims comprise any and all of such applications, modifications and embodiments within the scope of the present invention.

What is claimed is:

1. A method of adjusting timing advance for a multi-point cooperation communication system, comprising:
selecting at least one reception point as a reference point for a user equipment to adjust the timing advance; and
providing the selected at least one reference point to the user equipment.

2. The method according to claim 1, further comprising:
receiving, at the at least one reception point, an uplink reference signal from the user equipment; and
selecting, based on signal quality of the uplink reference signal, one of the at least one reception point as a reference point for the user equipment to adjust the timing advance, wherein the signal quality relates to signal strength or propagation delay of the uplink reference signal.

3. The method according to claim 1, wherein the providing the selected at least one reference point to the user equipment comprises providing the selected at least one reference point to the user equipment via radio resource control signaling.

4. A method of adjusting timing advance for a multi-point cooperation communication system, comprising:
recording a reception time of receiving a downlink reference signal from a reference point, wherein the reference point is one of the reception points in the multi-point cooperation communication system and is indicated via a serving base station; and
adjusting the timing advance for uplink transmission based on the recorded reception time and a timing advance command from the serving base station.

5. The method according to claim 4, wherein the adjusting the timing advance comprises adjusting the timing advance during the interval of receiving different timing advance commands from the serving base station.

6. The method according to claim 5, wherein the adjusting the timing advance comprises:
calculating a first difference between the reception time and an uplink transmission time determined by the timing advance command;
recording a reception time of receiving a next downlink reference signal from the reference point;
calculating a second difference between the next reception time and the determined uplink transmission time; and
adjusting the timing advance based on a difference between the second difference and the first difference.

7. An apparatus of adjusting timing advance for a multi-point cooperation communication system, comprising:
a module for selecting at least one reception point as a reference point for a user equipment to adjust the timing advance; and
a module for providing the selected at least one reference point to the user equipment.

8. The apparatus according to claim 7, further comprising:
a module for receiving, at the at least one reception point, an uplink reference signal from the user equipment; and
a module for selecting, based on signal quality of the uplink reference signal, one of the at least one reception point as a reference point for the user equipment to adjust the timing advance, wherein the signal quality relates to signal strength or propagation delay of the uplink reference signal.

9. The apparatus according to claim 7, wherein the module for providing the selected at least one reference point to the user equipment comprises a module for providing the selected at least one reference point to the user equipment via radio resource control signaling.

10. An apparatus of adjusting timing advance for a multi-point cooperation communication system, comprising:
a module for recording a reception time of receiving a downlink reference signal from a reference point, wherein the reference point is one of the reception points in the multi-point cooperation communication system and is indicated via a serving base station; and
a module for adjusting the timing advance for uplink transmission based on the recorded reception time and a timing advance command from the serving base station.

11. The apparatus according to claim 10, wherein the module for adjusting the timing advance comprises a module for adjusting the timing advance during the interval of receiving different timing advance commands from the serving base station.

12. The apparatus according to claim 11, wherein the module for adjusting the timing advance comprises:
a module for calculating a first difference between the reception time and an uplink transmission time determined by the timing advance command;
a module for recording a reception time of receiving a next downlink reference signal from the reference point;
a module for calculating a second difference between the next reception time and the determined uplink transmission time; and
a module for adjusting the timing advance based on a difference between the second difference and the first difference.

13. A base station comprising the apparatus according to claim 7.

14. A user equipment comprising the apparatus according to claim 10.
